(19) United States
(12) Patent Application Publication
(10) Pub. No.: US 2007/0226917 A1
(43) Pub. Date: Oct. 4, 2007

(54) Hair Dye Agent Comprising Organosilicon Copolymers with Amino Groups and Polyoxyalkylene Groups and Use Thereof

(75) Inventors: Astrid Kleen, Hamburg (DE); Christa Rohland, Dusseldorf (DE); Stephan Schwartz, Wedel (DE); Sarah Weishaupt, Hamburg (DE)

Correspondence Address: CONNOLLY BOVE LODGE & HUTZ LLP, PO BOX 2207, WILMINGTON, DE, 19899-2207, US

(73) Assignee: Henkel KGaA, Dusseldorf (DE)

(21) Appl. No.: 11/587,811

(22) PCT Filed: Dec. 3, 2004
(86) PCT No.: PCT/EP04/13758

§ 371 Date: Dec. 4, 2006

(30) Foreign Application Priority Data
Apr. 26, 2004 (DE) 10 2004 020 501.9

(51) Int. Cl. A61Q 5/10

(52) U.S. Cl. 8/406

(57) ABSTRACT

Oxidative dyeing agents for keratinic fibers comprising: (a) a component selected from the group consisting of direct dyes, dye precursors, and combinations thereof; and (b) an organosilicone block copolymer having one or more polyoxyalkylene blocks, one or more polysiloxane blocks and at least two amino groups covalently linked to the main polymer chain or to the chain ends, as well as their use and kits containing the same are described.

The present invention relates to the use of organosilicone copolymers in agents for the oxidative dyeing of keratinic fibers, especially of human hair, and to such agents and methods for dyeing keratinic fibers, especially a human hair.

Human hair is treated at the present time in various ways with cosmetic preparations. These include, for example, the cleaning of the hair with shampoos, the care and regeneration with rinses and courses of treatments, as well as the bleaching, coloring and shaping of hair with dyeing agents, tinting agents, waving agents and styling preparations. In this connection, agents for changing or nuancing the color of the hair of the head play an outstanding role.

For permanent, intensive dyeings with appropriate fastness properties, so-called oxidation dyes are used. Such dyeing agents usually contain precursors for the oxidation dyes, so-called developer components and coupler components. Under the influence of oxidizing agents or of oxygen from the air, the developer components form the actual dyes with one another or by coupling with one or more coupler components. Frequently, also combinations of oxidation dyes and direct dyes are used to achieve special nuances. The oxidation dyes are distinguished by outstanding, long-lasting dyeing results.

For temporary dyeings, dyeing agents or tints are usually used, which contain so-called direct dyes as the coloring component. These are dye molecules, which are exhausted directly onto the hair and do not require an oxidative process for developing the color. These dyes include, for example, henna, which was already known in ancient times for dyeing the body and hair. Usually, these dyeings are sensitive to shampooing, so that a frequently undesirable shift in nuance or even a visible “decolorization” can take place. It is a disadvantage of such temporary dyeings that they add to the natural hair shade and that therefore only nuances, which are darker then the original shade, are possible. For this reason, dyeing agents based on direct dyes, frequently are used in combination with oxidizing agent preparations, so that, aside from the actual dyeing, the starting shade of the fibers is also bleached.

Both processes therefore require the use of strong oxidizing agents, such as hydrogen peroxide solutions. These may damage the hair, which is to be dyed. Such damage must then be counteracted by using appropriate care products.

It has therefore long been customary to subject the hair to a special aftertreatment, in which the hair is treated with special active ingredients, such as quaternary ammonium salts or special polymers, which are usually in the form of rinses. Depending on the formulation, the combability, hold and fullness of the hair are improved and the splitting rate is decreased by this treatment.

The WO 99/09939 relates to a hair conditioner, which contains, among other constituents, polyoxyalkyleneamine-silicone copolymers. The copolymers preferably are block copolymers. In the examples, one of the constituents is a polyoxyalkylene-aminosilicone copolymer of the (AB)ₙ type, which is obtainable from OSi under the name of Silsoft® A 843. The publication deals, in particular, with conditioners. In addition, permanent waving agents, means for breaking up hairdos, dyeing or decolorizing agents are referred to overall. Oxidative hair-dyeing agents are not mentioned.

The WO 01/41721 relates to cosmetic compositions, which contain a block copolymer of the (AB)ₙ type, A being a polysiloxane block and B a block which has at least two quaternary ammonium groups. The cosmetic compositions endow improved cosmetic properties to the hair, such as easy combability, volume and gloss. They are used especially in agents for washing or conditioning hair. An overall reference is made once again to the use of permanent waving agents, means for breaking up hairdos, dyeing and decolorizing agents. Once again, there is no reference to agents for the oxidative dyeing of hair.

The WO 97/32917 relates to the use of aminosilicone-polyalkylene oxide block copolymers as softeners especially for textiles. Among other things, the treatment of hair is named as a further area of application.

The use of Silsoft® A-553 and Silsoft® A454 from Osi as color-maintaining conditioners is furthermore described in Eurocosmetis 3-2002, pages 20 to 24.

Furthermore, so-called combination preparations were developed recently, in order to reduce the effort involved in the usual multi-step methods, especially in the case of the direct application by the consumer.

These preparations contain, aside from the usual components, for example, for dyeing hair, additional active ingredients, which previously were reserved for aftertreatments of the hair. There is one application step fewer for the consumer; at the same time, the packaging costs are reduced, since one product fewer is used.

The active ingredients, which can be used within the scope of such combination preparations, must satisfy high requirements especially with regard to their stability, since the dyeing creams usually have a high pH and the preparations of oxidizing agents a low pH. Furthermore, incompatibilities among the various active ingredients and, with that, a short shelf life are to be avoided. For this reason, many components, used in aftertreatment agents, are unsuitable for combination preparations.

There is therefore a continuing need for active ingredients or combinations of active ingredients with good care properties, which can be used directly in agents for the oxidative dyeing of hair. Furthermore, there is a continuing demand for agents with an increased color intensity for the oxidative dyeing of hair.

It is an object of the present invention to make available agents for improving the wet and dry combability of hair as well as for increasing the color intensity. At the same time, it shall be possible to use these agents directly in agents for the oxidative dyeing of hair. With that, the agents are to be suitable for combination preparations.

Preferably, the care materials are to exhibit a high effectiveness already in small amounts.

Pursuant to the invention, the objectives are accomplished by the use of organosilicone copolymers, which, as block copolymers, contain polyoxyalkylene blocks, polysiloxane blocks and at least two amino groups, which are covalently bonded in the main polymer chain or to the chain ends, in agents for the oxidative dyeing of keratinic fibers, especially of a human hair.

Pursuant to the invention, it was found that organosilicone copolymers, which contain polyoxyalkylene blocks and polysiloxane blocks as block copolymers and at least two amino groups, which are covalently bonded in the main chain or at the chain ends of the polymers, can be used advantageously in agents for the oxidative dyeing particularly of human hair and, when used, improve the wet and dry combability of the hair as well as the color intensity of the hair dyeing. The care effect, attained by the use of the organosilicone copolymers, is maintained even after the hair is washed repeatedly, so that the organosilicone copolymer exhibits a sustained-release effect on the hair. A significant care performance is attained already when the organosilicone copolymer is used in small concentrations.

The organosilicone copolymers, used pursuant to the invention in agents for the oxidative dyeing, are known from the prior art. In this connection, reference is made, for example, to the publications named above.

Pursuant to the invention, it was found that the organic organosilicone copolymers named have a high compatibility with agents for the oxidative dyeing of hair, are stable under the use conditions for these agents and retain their advantageous effect.

The organosilicone copolymers, used pursuant to the invention, preferably are random block copolymers of polyoxyalkylene blocks and polysiloxanes blocks. The number and length of the blocks can be selected freely. The copolymers contain at least 2 and preferably at least 4 covalently linked amino groups in the main polymer chain or at the chain ends.

Preferably, the organosilicone copolymer contains polyethylene oxide and polypropylene oxide blocks and polydimethylsiloxane blocks.

Moreover, the organosilicone copolymers may contain primary and/or secondary and/or tertiary amino groups. In accordance with one embodiment of the invention, the block copolymer contains primary and/or secondary amino groups and especially primary and secondary amino groups. In accordance with a second embodiment, the block copolymer contains tertiary amino groups.

Preferably, the organosilicone copolymer contains repeating groups of Formula (I)
[SiMe₂-O—(SiMe₂-O—)ₓSiMe₂-R—NH—R′—O—(C₂H₄O)ₐ—(C₃H₆O)_{b}—R′NH—R] (I)
in which
x is a number from 3 to 500
a is a number from 1 to 300
b is a number from 0 to 300
R independently of one another represents bivalent organic groups, which are tied in to the main polymer chain over Si—C and C—N bonds,
R′ independently of one another represents bivalent organic groups, which are tied in to the main polymer chain over C—O and C—N bonds, Moreover, it is particularly preferred if x is a number from 5 to 300, a is a number from 5 to 200, b a number from 4 to 200, R a linear C₂₋₂₀ alkylene group and R′ a linear C₂₋₁₀ alkylene group, which, in each case, may be substituted by one or more OH groups and interrupted by one or more non-adjacent O—, —C(O)—, —O—C(O)—, —C(O)—O group.

It is especially preferred if x is a number from 10 to 300, a is number from 5 to 100, b a number from 5 to 100, R a linear C₃₋₁₀ alkylene group, which is substituted by at least one OH group and interrupted by at least one —O— group. R′ preferably represents a linear C₁₋₅ alkylene group.

Moreover, it is particularly preferred if terminal, primary amino groups are present. Especially preferred is a copolymer, which has two terminal primary amino groups and two secondary amino groups in the chain. Particularly preferably, the block copolymer also additionally has at least 2 and especially precisely 2 hydroxyl groups.

R, in particular, is an ethylene, propylene or butylene group, which preferably is linear or it is the —CH₂CH₂CH₂OCH(OH)CH₂— group.

R′ preferably is a divalent alkylene group, such as an ethylene, propylene or butylene group, which, in particular, is linear.

Particularly preferred is a copolymer of the general formula
H₂N(C₃H₆O)(C₂H₄O)CH₂CH₂NHCH₂C(OH)HCH₂—O—CH₂CH₂CH₂—(SiMe₂)(—O—Si-Me₂)—CH₂CH₂CH₂—O—CH₂—C(OH)H—CH₂NH₂(C₂H₄O)(C₃H₆O)C₃H₆—NH₂.

The siloxane blocks are present preferably in amounts of 50 to 95 mole percent and especially in amounts of 70 to 85 mole percent, based on the total block copolymer.

The amine content preferably ranges from 0.02 to 0.5 meq/g and especially from 0.05 to 0.2 meq/g of the copolymer in a 30% solution in dipropylene glycol.

The molecular weight of the block copolymer preferably is between 5000 and 1,000,000 and especially between 10,000 and 200,000.

The block copolymer may be produced by known methods, such as the reaction of a silicone diepoxide or a dichlorosilicone with a polyoxyalkylenediamine.

In particular, the product, obtainable under the name of Silsoft® A-843 from OSi, Greenwich, Conn. is used.

In accordance with a further embodiment of the invention, the organosilicone copolymer has tertiary amino groups. Moreover, the organosilicone copolymer preferably has repeating units of the general Formula (II)
[(SiMe₂-O—)_{y}SiMe₂-R¹—]ᵥNR²—[R³—(OC₂H₄)_{c}—(OC₃H₆)_{d}—R⁴—NR⁵—]_{w} (II)
in which
y represents a number from 3 to 500,
v represents a number from 1 to 50,
w represents a number from 1 to 50,
c represents a number from 1 to 300,
d represents a number from 0 to 300,
R′ independently of one another represents bivalent organic groups, which are tied in to the main polymer chain over Si—C and C—N bonds,
R³, R⁴ independently of one another represents bivalent organic groups, which are tied in to the main polymer chain over N—C and C—O bonds,
R⁵ represents a C₁₋₆ alkyl group or a phenyl group, which may be substituted by OH.

Particularly preferred are repeating units of the general Formula (II), in which y represents a number from 5 to 300, c represents a number from 5 to 200, d represents a number from 4 to 200, R¹, R³, R⁴, independently of one another are linear C₂₋₂₀ alkylene groups, each of which may be substituted by one or more OH groups and interrupted by one or more non-adjacent O—, —C(O)—, —O—C(O)—, —C(O)—O-groups and R², R⁵ independently of one another represent C₁₋₄ alkyl groups.

Block copolymers of the general Formula (II) are obtainable, for example, as Silsoft® A-553 from OSi.

The organosilicone copolymers may also be used in the form of reaction products, especially in the form of salts of fatty acids. Examples of suitable fatty acids are the C₁₆₋₃₀ fatty acids, stearic acid being a particularly preferred example. Silsoft® A-454 from OSi is such a suitable product.

According to the INCI, the name could be dimethicone bisamino hydroxyethyldihydroxypropyl copolyol/TEA stearate.

In the general Formula (II), R′ may have the same meaning as R in the general Formula (I). R³ may have the same meaning as R′ in the general Formula (1). In particular, these may be groups, which are substituted by hydroxyl groups and/or interrupted by oxygen atoms. A combination of a hydroxyl group and interrupting oxygen atom, which are present at carbon atoms, which are not adjacent to one another, is preferred.

R⁴ may have the same meaning as R³. However, it may also be a C₁₋₆ and preferably a C₂₋₃ alkylene group.

Suitable groups and their meanings are given, for instance, in the WO 97/32917.

The organosilicone copolymers, which are use pursuant to the invention, are prepared preferably also as described in WO 97/32917.

The inventive block copolymers are used in the agents for the oxidative dyeing preferably in amounts of 0.1 to 20% by weight, especially of 0.2 to 5% by weight and particularly of 0.3 to 3% by weight, based on the hair dyeing agent as a whole.

Moreover, they are used particularly for improving the wet and dry combability of the hair and for increasing the color intensity of the hair dyeing agents.

Pursuant to the invention, the use of the Silsoft® A 843 product of OSi is especially preferred.

The invention also relates to an agent for dyeing keratinic fibers and especially human hair, containing dye precursors as well as at least one block copolymer, as described above. Moreover, the agent preferably contains at least one developer component as dye precursor. Moreover, it may contain preferably at least one coupler component. In addition, it may contain preferably at least one direct dye.

In accordance with a particularly preferred embodiment, dyeing agents are used, which do not contain any ammonia.

Pursuant to the invention, keratinic fibers are understood to include fur, feathers and especially human hair.

Pursuant to the invention, it was found that the use of the block copolymers directly hair dyeing agents for the oxidative dyeing of hair leads not only to a significant improvement in the wet and dry combability of the hair directly after the dyeing, but, in addition, also to an intensification of the color. Moreover, it was possible to observe that the care withstands numerous shampoo washings and that therefore the organosilicone copolymer has a sustained-release effect.

Further important advantages of the copolymer, used pursuant to the invention for the formulation of hair dyeing agents, are the good water solubility and the stability of the compounds in a strongly alkaline medium. In addition, in comparison to known agents, the copolymers exhibit a lesser change in viscosity, so that the amount of copolymer, which can be used for the formulation of hair dyeing agents, has a larger range. In comparison to other, conventional care polymers used in hair-dyeing agents, the copolymers also exhibited a significant care performance when used in significantly lower concentrations.

Additional, possible components of the inventive agents for the oxidative dyeing of hair are explained in greater detail below.

In a first preferred embodiment, the inventive dyeing agents contain at least one dye precursor. With respect to the dye precursors used in the inventive dyeing agents, the present invention is not subjected to any limitations. As dye precursors, the inventive dyeing agents may contain
oxidation dye precursors of the developer or coupler type and
precursors of dyes, analogous to natural ones, such as indole and indoline derivatives, as well as mixtures of representatives of these groups.

As dye precursor, the inventive dyeing agents preferably contain at least one developer component. As developer component, usually primary aromatic amines with a further free or substituted hydroxy or amino group in the para or ortho position, diaminopyridine derivatives, heterocyclic hydrazones, 4-aminopyrazole derivatives as well as 2,4,5,6-tetraminopyrimidine are used.

Pursuant to the invention, it may be preferred to use a p-phenylene-diamine derivative or one of its physiologically acceptable salts as developer component. Especially preferred are p-phenylenediamine derivatives of Formula (E1) 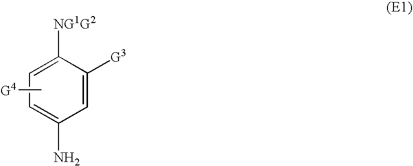
in which
G¹ represents a hydrogen atom, a C₁ to C₄ alkyl group, a C₁ to C₄ monohydroxyalkyl group, a C₂ to C₄ polyhydroxyalkyl group, a (C₁ to C₄)-alkoxy-(C₁ to C₄)-alkyl group, a 4′-aminophenyl group or a C₁— to C₄ alkyl group, which is substituted by a nitrogen-containing group, a phenyl group or a 4′-aminophenyl group;
G² represents a hydrogen atom, a C₁ to C₄ alkyl group, a C₁ to C₄ monohydroxyalkyl group, a C₂ to C₄ polyhydroxyalkyl group, a (C₁ to C₄)-alkoxy-(C₁ to C₄)-alkyl group or a C₁— to C₄ alkyl group, which is substituted by a nitrogen-containing group;
G³ represents a hydrogen atom, a halogen atom, such as a chlorine, bromine, iodine or fluorine atom, a C₁ to C₄ alkyl group, a C₁ to C₄ monohydroxyalkyl group, a C₂ to C₄ polyhydroxyalkyl group, a C₁ to C₄ hydroxyalkoxy group, a C₁ to C₄ acetylaminoalkoxy group, a C₁ to C₄ mesylaminoalkoxy group or a C₁ to C₄ carbamoylaminoalkoxy group;
G⁴ represents a hydrogen atom, a halogen atom or a C₁ to C₄ alkyl or
if G³ and G⁴ are ortho to one another, they may jointly represent an α,ω-alkylendioxy group, such as, for example, and ethylenedioxy group.

Examples of C₁ to C₄ alkyl groups, named as substituents in the inventive compounds, are the methyl, ethyl, propyl, isopropyl and butyl groups. Preferably, the alkyl groups are ethyl and methyl. C₁ to C₄ alkoxy groups, preferred pursuant to the invention, are, for example, a methoxy group or an ethoxy group. Furthermore, as preferred examples of a C₁ to C₄ hydroxyalkyl group, a hydroxymethyl, a 2-hydroxyethyl, a 3-hydroxypropyl or a 4-hydroxybutyl group may be mentioned. A 2-hydroxyethyl group is particularly preferred. Pursuant to the invention, examples of halogen atoms are fluorine, chlorine or bromine atoms, chlorine atoms being particularly preferred. The further concepts used are derived, pursuant to the invention, from the definitions given here. Examples of (nitrogen) containing groups of Formula (E1) are, in particular, the amino groups, C₁ to C₄ monoalkylamino groups, C₁ to C₄ dialkylamino groups, C₁ to C₄ trialkylammonium groups, C₁ to C₄ monohydroxyalkylamino groups, imidazolinium and ammonium.

Particularly preferred p-phenylenediamines of Formula (E1) are selected from p-phenylenediamine, p-toluenediamine, 2-chloro-p-phenylenediaminee, 2,3-dimethyl-p-phenylenediamine, 2,6-dimethyl-p-phenylenediamine, 2,6-diethyl-p-phenylenediamine, 2,5-dimethyl-p-phenylenediamine, N,N-dimethyl-p-phenylene-diamine, N,N-diethyl-p-phenylenediamine, N,N-dipropyl-p-phenylenediamine, 4-amino-3-methyl-(N,N-diethyl)-aniline, N,N-bis-(β-hydroxyethyl)-p-phenylenedi-amine, 4-N,N-bis-(β-hydroxyethyl)-amino-2-methyl-aniline, 4-N,N-bis-(β-hydroxy-ethyl)-amino-2-chloraniline, 2-(β-hydroxyethyl)-p-phenylenediamine, 2-fluoro-p-phenylenediamine, 2-isopropyl-p-phenylenediamine, N-(β-hydroxypropyl)-p-phenylenediamine, 2-hydroxymethyl-p-phenylenediamine, N,N-dimethyl-3-methyl-p-phenylenediamine, N,N-(ethyl,β-hydroxyethyl)-p-phenylenediamine, N-(β,γ-dihydroxypropyl)-p-phenylenediamine, N-(4′-amino-phenyl)-p-phenylenediamine, N-phenyl-p-phenylenediamine, 2-(β-hydroxyethyloxy)-p-phenylenediamine, 2-(β-acetylaminoethyloxy)-p-phenylenediamine, N-(βmethoxyethyl)-p-phenylenediamine and 5,8-diaminobenzo-1,4-dioxane, as well as their physiologically acceptable salts

Pursuant to the invention, p-phenylenediamine, p-toluoylenediamine, 2-(β-hydroxyethyl)-p-phenylenediamine and N,N-bis-(β-hydroxyethyl)-p-phenylene-diamine are particularly preferred as p-phenylenediamine derivatives.

Pursuant to the invention, the use of compounds, which contain at least two aromatic rings, which are substituted with amino and/or hydroxyl groups, as developer components, may furthermore be preferred.

Especially the compounds, which correspond to the following formula (E2), and their physiologically acceptable salts may be mentioned as developer components, which contain two aromatic rings and may be used in inventive dye compositions: 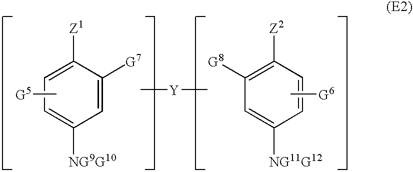
in which
Z¹ and Z² independently of one another represent a hydroxyl or NH₂ group, which optionally is substituted by a C₁ to C₄ alkyl group, by a C₁ to C₄ hydroxyalkyl group and/or by a bridging Y or which optionally is part of a bridging ring system,
the bridging Y represents an alkylene group with 1 to 14 carbon atoms, such as a linear or branched alkylene chain or an alkylene ring, which may be interrupted or terminated by one or more nitrogen-containing groups and/or one or more hetero atoms such as oxygen, sulfur or nitrogen atoms and possibly may be substituted by one or more hydroxyl or C₁ to C₈ alkoxy groups, or a direct bond,
G⁵ and G⁶ independently of one another represent a hydrogen atom or a halogen atom, a C₁ to C₄ alkyl group, a C₁ to C₄ monohydroxyalkyl group, a C₂ to C₄ polyhydroxyalkyl group, a C₁ to C₄ aminoalkyl group or a direct bond to the bridging Y,
G⁷, G⁸, G⁹, G¹⁰, G¹¹ and G¹² independently of one another represent a hydrogen atom, a direct bond to the bridging Y or a C₁ to C₄ alkyl group, with the proviso that
the compounds of Formula (E2) contained only one bridging Y per molecule and
the compounds of Formula (E2) contain at least one amino group, which carries at least one hydrogen atom.

Pursuant to the invention, the substituents, used in Formula (E2), are defined analogously to the above.

Preferred developer components of Formula (E2) with two aromatic rings are, in particular: N,N′-bis-(β-hydroxyethyl)-N,N′-bis-(4′-aminophenyl)-1,3-diamino-2-propanol, N,N′-bis-(β-hydroxyethyl)-N,N′-bis-(4′-aminophenyl)-ethylene-diamine, N,N′-bis-(4-aminophenyl)-tetramethylenediamine, N,N′-bis-(β-hydroxy-ethyl)-N,N′-bis-(4-aminophenyl)-tetramethylenediamine, N,N′-bis-(4-methyl-amino-phenyl)-tetramethylenediamine, N,N′-diethyl-N,N′-bis-(4′-amino-3′-methylphenyl)-ethylenediamine, bis-(2-hydroxy-5-aminophenyl)-methane, N,N′-bis-(4′-aminophenyl)-1,4-diazacycloheptane, N,N′-bis-(2-hydroxy-5-aminobenzyl)-piperazine, N-(4′-aminophenyl)-p-phenylenediamine and 1,10-bis-(2′,5′-diaminophenyl)-1,4,7,10-tetraoxadecane and their physiologically acceptable salts.

N,N′-Bis-(β-hydroxyethyl)-N,N′-bis-(4′-aminophenyl)-1,3-diamino-2-propan-ol, bis-(2-hy-droxy-5-aminophenyl)-methane, N,N′-bis-(4′-aminophenyl)-1,4-diazacycloheptane and 1,10-bis-(2′,5′-diaminophenyl)-1,4,7,10-tetraoxadecane are particularly preferred developer components of Formula (E2) having two aromatic rings.

Furthermore, pursuant to the invention, the use of a p-aminophenol derivative or its physiologically acceptable salts as developer component may be preferred. Particularly preferred are p-aminophenol derivatives of Formula (E3) 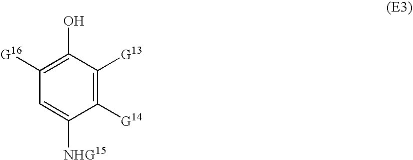
in which
G¹³ represents a hydrogen atom, a halogen atom, a C₁ to C₄ alkyl group, a C₁ to C₄ monohydroxy alkyl group, a C₂ to C₄ polyhydrorxyalkyl group, a (C₁— to C₄)-alkoxy-(C₁ to C₄)-alkyl group, a C₁ to C₄ aminoalkyl group, a hydroxy-(C₁ to C₄)-alkylamino group, a C₁ to C₄-hydroxyalkoxy group, a C₁ to C₄-hydroxyalkyl-(C₁ to C₄)-aminoalkyl group or a (di(C₁ to C₄) alkylamino)-(C₁ to C₄)-alkyl group and
G¹⁴ represents a hydrogen or halogen atom, a C₁ to C₄ alkyl group, a C₁ to C₄ monohydroxyalkyl group, a C₂ to C₄ polyhydroxyalkyl group, a (C₁ to C₄)-alkoxy-(C₁ to C₄)-alkyl group, a C₁ to C₄ aminoalkyl group or a C₁ to C₄ cyanoalkyl group,
G¹⁵ represents hydrogen, a C₁ to C₄ alkyl group, a C₁ to C₄ monohydroxyalkyl group, a C₂ to C₄ polyhydroxyalkyl group, a phenyl group or a benzyl group and
G¹⁶ represents hydrogen or a halogen atom.

Pursuant to the invention, the substituents, used in Formula (E3), are defined analogously to the above.

Preferred p-aminophenols of Formula (E3) are, in particular, p-aminophenol, N-methyl-p-aminophenol, 4-amino-3-methyl-phenol, 4-amino-3-fluoro-phenol, 2-hydroxymethylamino-4-aminophenol, 4-amino-3-hydroxymethylphenol, 4-amino-2-(□-hydroxyethoxy)-phenol, 4-amino-2-methylphenol, 4-amino-2-hydroxy-methylphenol, 4-amino-2-methoxymethyl-phenol, 4-amino-2-aminomethylphenol, 4-amino-2-(β-hydroxyethyl-aminomethyl)-phenol, 4-amino-2-fluorophenol, 4-amino-2-chlorophenol, 4-amino-2,6-dichlorophenol, 4-amino-2-(diethylaminomethyl)-phenol, as well as their physiologically acceptable salts.

Especially preferred compounds of Formula (E3) are p-aminophenol, 4-amino-3-methylphenol, 4-amino-2-aminomethylphenol and 4-amino-2-(diethyl-aminomethyl)-phenol.

Furthermore, the developer component may be selected from o-aminophenol and its derivatives, such as 2-amino-4-methylphenol, 2-amino-5-methylphenol or 2-amino-4-chlorphenol.

Moreover, the developer component may be selected from heterocyclic developer components, such as derivatives of pyridine, pyrimidines, pyrazole, pyrazole-pyrimidine and their physiologically acceptable salts.

Preferred pyridine derivatives are, in particular, the compounds described in the British patents 1,026,978 and 1,153,196, such as 2,5-diamino-pyridine, 2-(4′-methoxyphenyl)-amino-3-amino-pyridine, 2,3-diamino-6-methoxy-pyridine, 2-(β-methoxyethyl)-amino-3-amino-6-methoxy-pyridine and 3,4-diamino-pyridine.

Preferred pyrimidine derivatives are, in particular, the compounds, which are described in the German patent 2,359,399 and the Japanese patent 02019576 A2 or in the Offenlegungsschrift WO 96/15765, such as 2,4,5,6-tetraminopyrimidine, 4-hydroxy-2,5,6-triaminopyrimidine, 2-hydroxy-4,5,6-triaminopyrimidine, 2-dimethyl-amino-4,5,6-triaminopyrimidine, 2,4-dihydroxy-5,6-diaminopyrimidine and 2,5,6-triaminopyrimidine.

Preferred pyrazole derivatives are, in particular, the compounds, which are described in the patents DE-A-38 43 892, DE-A41 33 957 and the patent applications WO-A94/08 969, WO-A-94/08 970, EP-A-740 931 and DE-A-195 43 988, such as 4,5-diamino-1-methylpyrazole, 4,5-diamino-1-(β-hydroxyethyl)-pyrazole, 3,4-diaminopyrazole, 4,5-diamino-1-(4′-chlorobenzyl)-pyrazole, 4,5-diamino-1,3-dimethylpyrazole, 4,5-diamino-3-methyl-1-phenylpyrazole, 4,5-diamino-1-methyl-3-phenylpyrazole, 4-amino-1,3-dimethyl-5-hydrazinopyrazole, 1-benzyl-4,5-diamino-3-methylpyrazole, 4,5-diamino-3-t-butyl-1-methylpyrazole, 4,5-diamino-1-t-butyl-3-methylpyrazole, 4,5-diamino-1-(β-hydroxy-ethyl)-3-methylpyrazole, 4,5-diamino-1-ethyl-3-methylpyrazole, 4,5-diamino-1-ethyl-3-(4′-methoxyphenyl)-pyrazole, 4,5-diamino-1-ethyl-3-hydroxymethylpyrazole, 4,5-diamino-3-hydroxy-methyl-1-methylpyrazole, 4,5-diamino-3-hydroxymethyl-1-isopropylpyrazole, 4,5-diamino-3-methyl-1-isopropylpyrazole, 4-amino-5-(□-aminoethyl)-amino-1,3-di-methyl-pyrazole, 3,4,5-triaminopyrazole, 1-methyl-3,4,5-triaminopyrazole, 3,5-diamino-1-methyl-4-methylaminopyrazole and 3,5-diamino-4-(β-hydroxyethyl)-amino-1-methylpyrazole.

Preferred pyrazole-pyrimidine derivatives are, in particular, the derivatives of pyrazole-[1,5-a]-pyrimidine of the following formula (E4) and its tautomeric forms, provided that there is a tautomeric equilibrium. 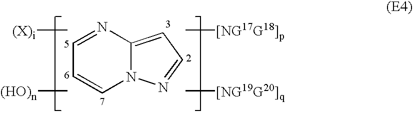
in which
G¹⁷, G¹⁸, G¹⁹ and G²⁰ independently of one another represent a hydrogen atom, a C₁ to C₄ alkyl group, an aryl group, a C₁ to C₄ hydroxyalkyl group, a C₂ to C₄ polyhydroxyalkyl group, a (C₁ to C₄)-alkoxy-(C₁ to C₄)-alkyl group, a C₁ to C₄ aminoalkyl group, which optionally may be protected by an acetyl ureide group or a sulfonyl group, a (C₁ to C₄)-alkylamino-(C₁ to C₄)-alkyl group, a di-[(C₁ to C₄)-alkyl]-(C₁ to C₄)-aminoalkyl group, the dialkyl groups optionally forming a carbocyclic compound or a heterocyclic compound with 5 or 6 chain elements, a C₁ to C₄ hydroxyalkyl group or a di-(C₁ to C₄)-[hydroxyalkyl]-(C₁ to C₄)-aminoalkyl group,
the X groups represent, independently of one another, a hydrogen atom, a C₁ to C₄ hydroxyalkyl group, a C₂ to C₄ polyhydroxyalkyl group, a C₁ to C₄ aminoalkyl group, a (C₁ to C₄)-alkylamino-(C₁ to C₄)-alkyl group, a di-[(C₁ to C₄)alkyl]-(C₁ to C₄)-aminoalkyl group, the dialkyl groups optionally forming a carbocyclic group or a heterocyclic group with 5 or 6 chain elements, a C₁ to C₄ hydroxyalkyl group or a di-(C₁ to C₄ hydroxyalkyl)-aminoalkyl group, an amino group, a C₁ to C₄ alkyl group or a di-(C₁ to C₄ hydroxyalkyl)-amino group, a halogen atom, a carboxylic acid group or a sulfonic acid group,
i has a value of 0, 1, 2 or 3,
p has a value of 0 or 1,
q has a value of 0 or 1 and
n has a value of 0 or 1,
   with the proviso that
the sum of p+q is not equal to 0,
if p+q is equal to 2, n does not have a value of 0 and the NG¹⁷G¹⁸ and NG¹⁹G²⁰ groups occupy the positions (2, 3); (5, 6); (6, 7); (3, 5) or (3, 7);
if p+q is equal to 1, n has the value of 1 and the NG¹⁷G¹⁸ (or NG¹⁹G²⁰) groups and the OH group occupy the positions (2, 3); (5, 6); (6, 7); (3, 5) or (3, 7).

Pursuant to the invention, the substituents, used in Formula (E4), are defined analogously to the above.

If the pyrazole-[1,5-a]-pyrimidine of Formula (E4) above contains a hydroxyl group at one of the 2, 5 or 7 positions of the ring system, there is a tautomeric equilibrium, which is shown, for example, in the following equation:

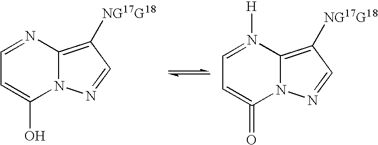

The pyrazole-[1,5-a]-pyrimidine of the above Formula (E4) includes, in particular:
pyrazole-[1,5-a]-pyrimidine-3,7-diamine;
2,5-dimethyl-pyrazole-[1,5-a]-pyrimidine-3,7-diamine;
pyrazole-[1,5-a]-pyrimidine-3,5-diamine;
2,7-dimethyl-pyrazole-[1,5-a]-pyrimidine-3,5-diamine;
3-aminopyrazole-[1,5-a]-7-pyrimidineol;
3-aminopyrazole-[1,5-a]-5-pyrimidinol;
2-(3-aminopyrazole-[1,5-a]-pyrimidine-7-ylamino)-ethanol;
2-(7-aminopyrazole-[1,5-a]-pyrimidine-3-ylamino)-ethanol;
2-[(3-aminopyrazole-[1,5-a]-pyrimidine-7-yl)-(2-hydroxy-ethyl)-amino]-ethanol;
2-[(7-aminopyrazole-[1,5-a]-pyrimidine-3-yl)-(2-hydroxy-ethyl)-amino]-ethanol;
5,6-dimethylpyrazole-[1,5-a]-pyrimidine-3,7-diamine;
2,6-dimethylpyrazole-[1,5-a]-pyrimidine-3,7-diamine;
3-amino-7-dimethylamino-2,5-dimethylpyrazole
   as well as their physiologically acceptable salts and their tautomeric forms, if there is a tautomeric equilibrium.

The pyrazole-[1,5-a]-pyrimidines of the above Formula (E4) can be synthesized, as described in the literature, by cyclization starting out from an aminopyrazole or a hydrazine.

Furthermore, the inventive agents may contain cationic dye precursors of the coupler and/or developer type, as described, for example, in the publications WO-A1-99/03 819, WO-A2-99/03 834, WO-A1-99/03 836, WO-A1-99/48 856, WO-A1-99/48 874, WO-A1-99/48 875, WO-A2-00/42 971, WO-A1-00/42 979, WO-A1-00/42 980, WO-A1-00/43 356, WO-A1-00/43 367, WO-A1-00/43 368, WO-A1-00/43 386, WO-A1-00/43 388, WO-A1-00/43 389, WO-A1-00/43 396, EP-A1-0 984 006, EP-A1-0 984 007 and EP-A1-0 989 128.

The following are particularly preferred cationic dye precursors:
[2-(2′,5′-diamino-phenoxy)-ethyl]-diethyl-methyl-ammonium chloride,
[2-(4′-amino-phenylamino)-propyl]-trimethylammonium chloride,
[4-(4′-amino-phenylamino)-pentyl]-diethyl-(2-hydroxyethyl)-ammonium chloride,
1-{[5′-amino-2′-(2″-hydroxyethylamino)-phenylcarbamoyl]-methyl}-1,4-dimethyl-1-piperazinium chloride,
1,4-bis-I-3-[3′-(2″,5″-diamino-phenoxy)-propyl]-3H-1-imidazolium)butane dichloride,
1,3-bis-[3′-(2″,5″-diamino-phenoxy)-propyl]-3H-1-imidazolium chloride
N,N′-bis-[3-N-methyl-4-N-(4′-amino-aniline)-ethyl]-1,1,4,4-tetramethyl-diammonium-1,3-propane dibromide,
1,3-bis-1-{3-{3′-[(4″-amino-3″-methyl-aniline)-N-propyl]}3H-1-imidazolium}-propane dichloride
1,3-bis-1-{3-{3′-[(4″-amino-aniline)-N-propyl]}3H-1-imidazolium}-propane dichloride
1,3-bis-1-{3-{3′-[(4″-amino-2″-methylaniline)-N-propyl]}3H-1-imidazolium}-propane dichloride
3-[3-(4′-amino-phenylamino)-propyl]-1-methyl-3H-1-imidazolium chloride
[3-(2′,5′-diamino-phenoxy)-propyl]-3-methyl-3H-1-imidazolium chloride
3-[3-(4′-amino-3′-methyl-phenylamino)-propyl]-1-methyl-3H-1-imidazolium chloride
3-[3-(4′-amino-2′-methyl-phenylamino)-propyl]-1-methyl-3H-1-imidazolium chloride
1-[2-(4′-amino-2′-methoxy-phenylamino)-ethyl]-3-methyl-3H-1-imidazolium chloride
3-[3-(4′-amino-2′-fluoro-phenylamino)-propyl]-1-methyl-3H-1-imidazolium chloride
3-[3-(4′-amino-2′-cyano-phenylamino)-propyl]-1-methyl-3H-1-imidazolium chloride
3-[2-(2′,5′-diamino-phenyl)-ethyl]-1-methyl-3H-1-imidazolium chloride
1-{2-[(4′-amino-phenyl)-ethyl-amino]-ethyl}-3-methyl-3H-1-imidazolium chloride
N,N-bis-[2-(3′-methyl-3H-1-imidazolium)ethyl]-4-amino-aniline chloride
3-[2-(4′-amino-phenylamino)-butyl]-1-methyl-3H-1-imidazolium chloride
[2-(2′,4′-diamino-phenoxy)-ethyl]-diethyl-methyl-ammonium chloride
1-[3-(2′,4′-diamino-phenoxy)-propyl]-3-methyl-3H-1-imidazolium chloride
1-[(3′-hydroxy-4′-methyl-phenylcarbamoyl)-methyl]-3-methyl-3H-1-imidazolium chloride
1,4-bis-1-{3-[3-(2′,4′-diamino-phenoxy)-propyl]-3H-1-imidazolium}-butane dichloride
3-[(3′-hydroxy-4′-methanesulfonylamino-phenylcarbamoyl)-methyl]-1-methyl-3H-1-imidazolium chloride
3-[(3′,5′-dichloro-2′-hydroxy-4′-methyl-phenylcarbamoyl)-methyl]-1-methyl-3H-1-imidazolium chloride
1-[(3′,5′-dichloro-2′-hydroxy-4′-methyl-phenylcarbamoyl)-methyl]-1,4-dimethyl-1-piperazinium chloride
3-[(4′-acetylamino-2′-hydroxy-phenylcarbamoyl)-methyl]-1-methyl-3H-1-imidazolium chloride
4-{3-[(3′-hydroxy-naphthalene-2′-carbonyl)-amino]-propyl}-4-methyl-4-morpholinium iodide
3-[(1′-hydroxy-naphthalene-2′-ylcarbamoyl)-methyl]-1-methyl-3H-1-imidazolium chloride
3-[(5′-acetylamino-1′-hydroxy-naphthalene-2′-ylcarbamoyl)-methyl]-1-methyl-3H-1-imidazolium chloride
3-[(1′-hydroxy-5′-methanesulfonylamino-naphthalene-2′-ylcarbamoyl)-methyl]-1-methyl-3H-1-imidazolium chloride
[3-(4′-amino-2′,5′-dimethyl-2H-pyrazole-3′-ylamino)-propyl]-(2-hydroxyethyl)-dimethylammonium chloride
1,3-bis-[(2′-hydroxy-4′-methyl-phenylcarbamoyl)-methyl]-3H-1-imidazolium chloride
1-[2-(6′-amino-benzo[1,3]dioxol-5′-ylamino)-ethyl]-3-methyl-3H-1-imidazolium chloride
3-[2-(6′-amino-benzo[1,3]dioxol-5′-ylamino)-ethyl]-1-(4-{3-[2-(6″-amino-benzo[1,3]dioxol-5″-ylamino)-ethyl]-3H-1-imidazolium}-butyl)-3H-1-imidazolium dichloride
3-[3-(3′-amino-5′-methyl-pyrazolo[1,5-a]pyrimidin-7′-ylamino)-propyl]-1-(2-hydroxyethyl)-3H-1-imidazolium chloride
1,3-bis-1-{3-{3-[(2′-amino-aniline)-N-propyl]}-3H-1-imidazolium}-propane dibromide
N,N′-bis-[3-N-(2′-amino-aniline)-N-propyl]-1,1,3,3-tetramethyl-diammonium-1,3-propane dibromide
3-[3-(2′-aminophenylamino)-propyl]-1-methyl-3H-1-imidazolium chloride
[2-(2′-aminophenylamino)-ethyl]-trimethylammonium chloride and
3-(4′-hydroxy-1′-methyl-1H-indole-5′-ylmethyl)-1-methyl-pyridinium methosulfate.

Furthermore, inventive dyeing agents are preferred, which contain at least one coupler component as dye precursor. Usually, as coupler component, m-phenylenediamine derivatives, naphthols, resorcinols and resorcinol derivatives, pyrazolones and m-aminophenol derivatives are used. In particular, 1-naphthol, 1,5-, 2,7- and 1,7-dihydroxynaphthalene, 5-amino-2-methylphenol, m-aminophenol, resorcinol, resorcinol monomethyl ether, m-phenylendiamine, 1-phenyl-3-methyl-5-pyrazolone, 2,4-dichloro-3-aminophenol, 1,3-bis-(2,4-diaminophenoxy)-propane, 2-chlororesorcinol, 4-chlororesorcinol, 2-chloro-6-methyl-3-aminophenol, 2-amino-3-hydroxypyridine, 2-methylresorcinol, 5-methylresorcinol and 2-methyl-4-chloro-5-aminophenol are suitable as coupler substances.

Coupler components, preferred pursuant to the invention, are:
m-aminophenol and its derivatives, such as 5-amino-2-methylphenol, 3-amino-2-chloro-6-methylphenol, 2-hydroxy-4-aminophenoxyethanol, 2,6-dimethyl-3-aminophenol, 3-trifluoroacetylamino-2-chloro-6-methylphenol, 5-amino-4-chloro-2-methylphenol, 5-amino-4-methoxy-2-methylphenol, 5-(2′-hydroxyethyl)-amino-2-methylphenol, 3-(diethylamino)-phenol, N-cyclo-pentyl-3-aminophenol, 1,3-dihydroxy-5-(methylamino)-benzene, 3-(ethyl-amino)-4-methylphenol and 2,4-dichloro-3-aminophenol,
o-aminophenol and its derivatives,
m-diaminobenzene and its derivatives, such as 2,4-diaminophenoxy-ethanol, 1,3-bis-(2,4-diaminophenoxy)-propane, 1-methoxy-2-amino-4-(2′-hydroxyethylamino)benzene, 1,3-bis-(2,4-diaminophenyl)-propane, 2,6-bis-(2-hydroxyethylamino)-1-methylbenzene and 1-amino-3-bis-(2′-hydroxyethyl)-aminobenzene,
o-diaminobenzene and its derivatives such as 3,4-diaminobenzoic acid and 2,3-diamino-1-methylbenzene,
di- or trihydroxybenzene derivatives such as resorcinol, resorcinol monomethyl ether, 2-methylresorcinol, 5-methylresorcinol, 2,5-dimethylresorcinol, 2-chlororesorcinol, 4-chlororesorcinol, pyrogallol and 1,2,4-trihydroxybenzene,
pyridine derivatives, such as 2,6-dihydroxypyridine, 2-amino-3-hydroxypyridine, 2-amino-5-chloro-3-hydroxypyridine, 3-amino-2-methyl-amino-6-methoxypyridine, 2,6-dihydroxy-3,4-dimethylpyridine, 2,6-di-hydroxy-4-methylpyridine, 2,6-diaminopyridine, 2,3-diamino-6-methoxy-pyridine and 3,5-diamino-2,6-dimethoxypyridine,
naphthalene derivatives, such as 1-naphthol, 2-methyl-1-naphthol, 2-hydroxymethyl-1-naphthol, 2-hydroxyethyl-1-naphthol, 1,5-dihydroxynaphthalene, 1,6-dihydroxynaphthalene, 1,7-dihydroxynaphthalene, 1,8-dihydroxy-naphthalene, 2,7-dihydroxy-naphthalene and 2,3-dihydroxynaphthalene,
morpholine derivatives such as 6-hydroxybenzomorpholine und 6-amino-benzomorpholine,
quinoxaline derivatives, such as 6-methyl-1,2,3,4-tetrahydroquinoxaline
pyrazole derivatives, such as 1-phenyl-3-methyl-5-pyrazolone,
indole derivatives, such as 4-hydroxyindole, 6-hydroxyindole and 7-hydroxy-indole
pyrimidine, such as 4,6-diaminopyrimidine, 4-amino-2,6-dihydroxy-pyrimidine, 2,4-diamino-6-hydroxypyrimidine, 2,4,6-trihydroxypyrimidine, 2-amino-4-methylpyrimidine, 2-amino-4-hydroxy-6-methylpyrimidine and 4,6-dihydroxy-2-methylpyrimidine, or
methylenedioxybenzene derivatives, such as 1-hydroxy-3,4-methylene-dioxybenzene, 1-amino-3,4-methylendioxybenzene und 1-(2′-hydroxyethyl)-amino-3,4-methylendioxybenzene.

Especially preferred coupler components are 1-naphthol, 1,5-, 2,7- and 1,7-dihydroxynaphthalene, 3-aminophenol, 5-amino-2-methylphenol, 2-amino-3-hydroxypyridine, resorcinol, 4-chlororesorcinol, 2-chloro-6-methyl-3-aminophenol, 2-methylresorcinol, 5-methylresorcinol, 2,5-dimethylresorcinol and 2,6-dihydroxy-3,4-dimethylpyridine.

If the dye precursors are amino compounds, acid addition salts can be produced from them in the usual way. All statements therefore refer to the compounds, which are present in the free-form, as well as to their water-soluble physiologically acceptable salts. Examples of such salts are the hydrochloride, the hydrobromides, the sulfates, the phosphates, the acetates, the propionates, the citrates and the lactates.

The oxidation dye precursors of the developer/coupler type are contained in the inventive agents preferably in amounts of 0.01 to 20% by weight and preferably of 0.01 to 5% by weight, in each case based on the total agent.

Furthermore, pursuant to the invention, precursors of dyes, which are analogous to natural ones, are preferred as dye precursors. As precursors of dyes, which are analogous to natural ones, preferably indole and indoline are used, which contain at least one hydroxy or amino group, preferably as a substituent on the six-membered ring. The groups may carry further substituents, for example, in the form of an etherification or esterification of the hydroxy group or an alkylation of the amino group. In a second, preferred embodiment, the dyeing agents contain at least one indole and/or indoline derivative.

Particularly suitable as precursors of hair dyes, analogous to natural dyes, are derivatives of 5,6-dihydroxyindoline of Formula (Ia) 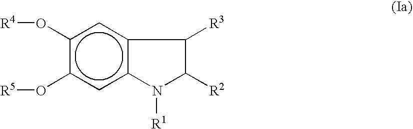
in which, independently of one another,
R¹ represents hydrogen, a C₁ to C₄ alkyl group, a C₁ to C₄ hydroxyalkyl group or a C₂ to C₄ polyhydroxyalkyl group,
R² represents hydrogen or a —COOH group, which may also be present as the salt of a physiologically acceptable cation,
R³ represents hydrogen, a C₁ to C₄ alkyl group,
R⁴ represents hydrogen, a C₁ to C₄ alkyl group or a —CO—R⁶ group, in which R⁶ represents a C₁ to C₄ alkyl group and
R⁵ represents one of the groups named under R⁴, as well as physiologically acceptable salts of these compounds with an organic or inorganic acid.

Particularly preferred derivatives of indoline are 5,6-dihydroxyindoline, N-methyl-5,6-dihydroxyindoline, N-ethyl-5,6-dihydroxyindoline, N-propyl-5,6-dihydroxyindoline, N-butyl-5,6-dihydroxyindoline, 5,6-dihydroxyindoline-2-carbox-ylic acid as well as 6-hydroxyindoline, 6-aminoindoline and 4-aminoindoline.

Within this group, N-Methyl-5,6-dihydroxyindoline, N-ethyl-5,6-dihydroxyindoline, N-propyl-5,6-dihydroxyindoline, N-butyl-5,6-dihydroxy-indoline and, in particular, 5,6-dihydroxyindoline are to be emphasized especially.

Outstandingly suitable as precursors of hair dyes, which are analogous to natural dyes, furthermore are derivatives of 5,6-dihydroxyindoline of Formula (Ib) 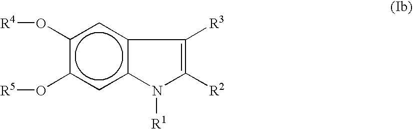
in which, independently of one another,
R¹ represents hydrogen, a C₁ to C₄ alkyl group, a C₁ to C₄ hydroxyalkyl group or a C₂ to C₄ polyhydroxyalkyl group,
R² represents hydrogen or a —COOH group, which may also be present as the salt of a physiologically acceptable cation,
R³ represents hydrogen, a C₁ to C₄ alkyl group,
R⁴ represents hydrogen, a C₁ to C₄ alkyl group or a —CO—R⁶ group, in which R⁶ represents a C₁ to C₄ alkyl group and
R⁵ represents one of the groups named under R⁴,
as well as physiologically acceptable salts of these compounds with an organic or inorganic acid.

Especially preferred derivatives of indole are 5,6-dihydroxyindole, N-methyl-5,6-dihydroxyindole, N-ethyl-5,6-dihydroxyindole, N-propyl-5,6-dihydroxy-indole, N-butyl-5,6-dihydroxyindole, 5,6-dihydroxyindole-2-carboxylic acid, 6-hydroxyindole, 6-aminoindole and 4-aminoindole.

Within this group, N-methyl-5,6-dihydroxyindole, N-ethyl-5,6-dihydroxyindole, N-propyl-5,6-dihydroxyindole, N-butyl-5,6-dihydroxyindole, as well as, in particular, 5,6-dihydroxyindole are to be emphasized.

Within the scope of the dyeing agents, used in the inventive method, the indoline derivatives and indole derivatives may be used as free bases as well as in the form of their physiologically acceptable salts with inorganic or organic acids, such as the hydrochlorides, the sulfates and the hydrobromides. The indole or indoline derivatives are contained in these usually in amounts of 0.05 to 10% by weight and preferably of 0.2 to 5% by weight.

In a further embodiment, the use of indoline or an indoline derivative in hair dyeing agents, in combination with at least one amino acid or an oligopeptide, maybe preferred pursuant to the invention. Advantageously, the amino acid is an α-amino acid, arginine in particular, ornithine, lysine, serine and histidine being especially preferred.

In a second preferred embodiment of the present invention, the dyeing agents contain at least one direct dye. In this connection, it is immaterial for the inventive teaching whether the dyeing agent is based only on direct dyes or whether the latter are contained in combination with the above-mentioned dye precursors in order to achieve the desired dyeing effects.

Direct dyes usually are nitrophenylendiamines, nitro-aminophenols, azo dyes, anthraquinones or indophenols. Preferred direct dyes are compounds known under the international names or commercial names of HC Yellow 2, HC Yellow 4, HC Yellow 5, HC Yellow 6, HC Yellow 12, HC Orange 1, Disperse Orange 3, HC Red 1, HC Red 3, HC Red 10, HC Red 11, HC Red 13, HC Red BN, HC Blue 2, HC Blue 12, Disperse Blue 3, HC Violet 1, Disperse Violet 1, Disperse Violet 4, Acid Violet 43, Disperse Black 9 and Acid Black 52, as well as 1,4-diamino-2-nitrobenzene, 2-amino-4-nitrophenol, 1,4-bis-(β-hydroxyethyl)-amino-2-nitrobenzene, 3-nitro-4-(β-hydroxyethyl)-aminophenol, 2-(2′-hydroxyethyl)-amino-4,6-dinitrophenol, 1-(2′-hydroxyethyl)amino-4-methyl-2-nitrobenzene, 1-amino-4-(2′-hydroxyethyl)-amino-5-chloro-2-nitrobenzene, 4-amino-3-nitrophenol, 1-(2′-ureido-ethyl)amino-4-nitrobenzene, 4-amino-2-nitrodiphenylamine-2′-carboxylic acid, 6-nitro-1,2,3,4-tetrahydroquinoxaline, 2-hydroxy-1,4-naphtho-quinone, hydroxyethyl-2-nitro-toluidine, picramic acid and its salts, 2-amino-6-chloro-4-nitrophenol, 4-ethylamino-3-nitrobenzoic acid and 2-chloro-6-ethylamino-1-hydroxy-4-nitro-benzene.

Furthermore, the inventive agents may contain a cationic direct dye. In this connection, the following are particularly preferred:
1. cationic triphenylmethane dyes, such as Basic Blue 7, Basic Blue 26, Basic Violet 2 and Basic Violet 14,
2. aromatic systems, which carry a quaternary nitrogen group substituent, such as Basic Yellow 57, Basic Red 76, and Basic Blue 99, Basic Brown 16 and Basic Brown 17, as well as
3. direct dyes, which contain a heterocyclic group, which has at least one quaternary nitrogen atom, such as mentioned in claims 6 to 11 of the EP-A2 998 908, to which reference is made explicitly here.

Especially the following compounds are preferred cationic direct dyes of group (iii):

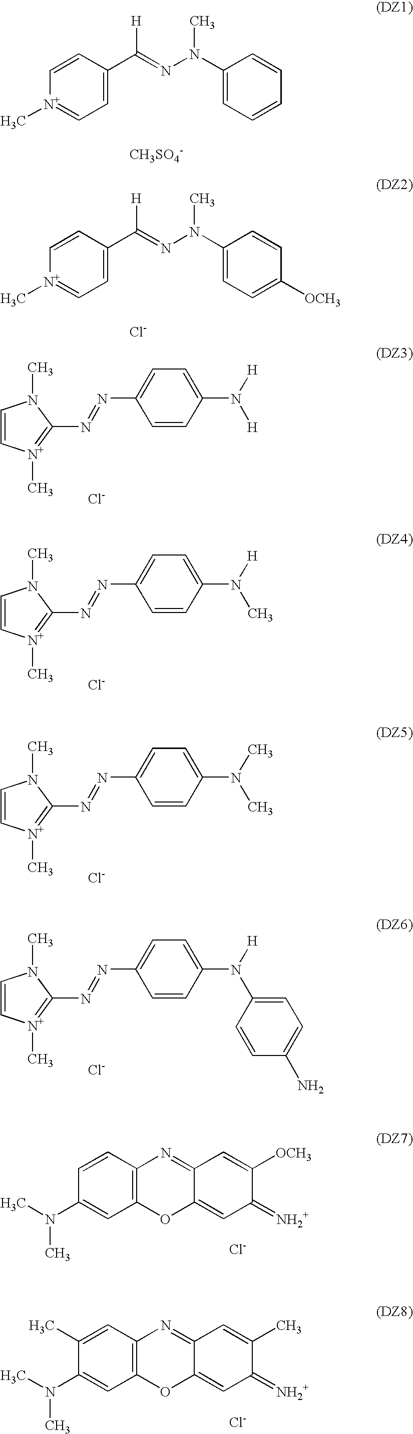

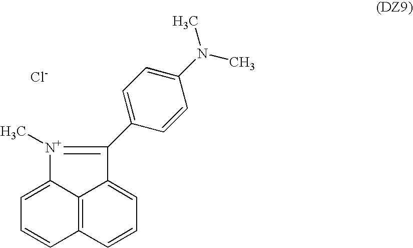

The compounds of Formulas (DZ1), (DZ3) and (DZ5) are particularly preferred cationic direct dyes of group (iii).

The inventive agents of this embodiment contain the direct dyes preferably in an amount of 0.01 to 20% by weight, based on the total dyeing agent.

Furthermore, the inventive preparations may also contain naturally occurring dyes, such as henna red, henna neutral, henna black, chamomile flowers, sandalwood, black tea, black alder bark, sage, logwood, madder root, catechu, sedre and alkanet.

The oxidation dye precursors or the direct dyes need not necessarily represent uniform compounds in each case. Instead, due to the methods of producing the individual dyes, other components may be contained in subordinate amounts in the inventive hair-dyeing agents, provided that they do not have a negative effect on the dyeing result or are precluded for other reasons, such as toxicological reasons.

With respect to the dyes, which can be used in the inventive hair dyeing and tinting agents, reference is furthermore made explicitly to the Ch. Zviak monograph, “The Science of Hair Care, Chapter 7, (pages 248-250; Direct Dyes), as well as to Chapter 8, pages 264-267, Oxidation Dye Precursors), published as Volume 7 of the series “Dermatology” (by: Ch. Culnan and H. Maibach), Marcel Dekker Inc., New York, Basel, 1986, as well as to the “Europaische Inventar der Kosmetik-Rohstoffe (European Inventory of Cosmetic Raw Materials)” published by the European Community, obtainable in diskette form from Bundesverband Deutscher Industrie-und Handelsuntemehmen für Arzneimittel, Reformwaren und Körperpflegemittel e.V., Mannheim.

Hair dyeing agents, especially when the dyeing is carried out oxidatively with oxygen from the air or with other oxidizing agents, such as hydrogen peroxide, usually are adjusted to a weakly acidic to alkaline pH, that is, to pH values ranging from about 5 to 11. For this purpose, the dyeing agents contain alkalizing agents, usually alkali or alkaline earth hydroxides, ammonia or organic amines. Preferred alkalizing agents are monoethaloamine, monoisopropanolamine, 2-amino-2-methyl-propanol, 2-amino-2-methyl-1,3-dihydroxypropane, 2-amino-2-ethyl-1,3-dihydroxypropane, 2-amino-2-methylbutanol and triethanolamine, as well as alkali and alkaline earth hydroxide. Monoethanolamine, triethanolamine, as well as 2-amino-2-methyl-propanol and 2-amino-2-methyl-1,3-dihydroxypropane are especially preferred within the scope of this group. The use of ω-amino acids, such as ω-aminocaproic acid, as alkalizing agent is also possible. Ammonia is a particularly preferred alkalizing agent.

If the actual hair colors are developed within the scope of an oxidative process, conventional oxidizing agents, such as, in particular, hydrogen peroxide or its addition products with urea, melamine or sodium borate, can be used. The oxidation with oxygen from the air as sole oxidizing agent may, however, be preferred. Furthermore, it is possible to carry out the oxidation with the help of enzymes, the enzymes being used to generate oxidizing per compounds as well as to reinforce the action of a small amount of oxidizing agent present. Accordingly, the enzymes (enzyme class 1: oxidoreductases) can transfer electrons from suitable developer components (reducing agents) to the oxygen from the air. In this connection, oxidases such as tyrosinase and laccase, as well glucose oxidase, uricase or pyruvate oxidase are preferred. Furthermore, the procedure is mentioned in which the effect of small amounts (for example 1% and less, based on the whole of the agent) of hydrogen peroxide is intensified by peroxidases.

Particularly in the case of hair, which is difficult to dye, the preparation with the dye precursors can be applied on the hair without first being mixed with the oxidizing component. After a period of action of 20 to 30 minutes, the oxidizing component is then applied, optionally after an intermediate rinsing. After a further period of action of 10 to 20 minutes, the hair is then rinsed and, if desired, shampooed once more. In the case of a first variation of this embodiment, for which the prior application of the dye precursor is to bring about a better penetration into the hair, the corresponding agent is adjusted to a pH of about 4 to 7. In accordance with a second variation, air oxidation is aimed for at first, the agent applied preferably having a pH of 7 to 10. For the accelerated subsequent oxidation, the use of peroxydisulfate solutions, adjusted to an acidic pH, may be preferred as oxidizing agent.

Irrespective of which of the above-named procedures is used within the scope of the inventive method, the development of the dyeing can be supported and increased owing to the fact that certain metal ions are added to the agent. Such metal ions are, for example, Zn²⁺, Cu²⁺, Fe²⁺, Fe³⁺, Mn²⁺, Mn⁴⁺, Li⁺, Mg²⁺, Ca²⁺ and Al³⁺, Zn²⁺, Cu²⁺, Mn²⁺ being particularly suitable. In principle, the metal ions may be used in the form of any physiologically acceptable salts and. Acetates, sulfates, halides, lactates and tartrates are preferred salts. The use of these metal salts can accelerate the coloration and selectively influence the color shade.

Irrespective of the nature of the dyeing agent, the mixing of the dyeing agent immediately before use with an oxidizing agent preparation is preferred pursuant to the invention.

A further object of the present invention therefore as a method for dyeing keratinic fibers, for which one of the inventive agents is mixed immediately before use with an oxidizing agent preparation, the resulting application preparation being applied on the fibers and, after a period of action, being washed off once again.

In a further embodiment of the present invention, a dyeing cream is applied on the hair to start with and, after a period of action, an agent, obtainable by mixing the actual dyeing cream with the oxidizing agent preparation, is applied.

A further object of the present invention therefore is a method for dyeing keratinic fibers, for which one of the inventive agent is applied on the fibers and, after a period of action, a second preparation, which is obtained by mixing one of the inventive agents with an oxidizing agent preparation immediately before use, is applied on the fibers and, after a further period of action, the fibers are rinsed thoroughly.

Although, in principle, all oxidizing agents, which are known to be suitable for dyeing hair, can be used, hydrogen peroxide is preferred pursuant to the invention. The preparation of oxidizing agent, based on hydrogen peroxide, preferably has a pH of 1 to 6 and preferably of 2 to 4. Immediately before use, the dye (precursor) preparation and the preparation of oxidizing agent are mixed in a ratio of 4:1 to 1:3 and especially of 2;1 to 1:1. The resulting application preparation should, preferably, have a pH ranging from 6 to 12 and especially from 9 to 11. Especially preferred is the use of the hair dyeing agent in a weekly alkaline medium. The application temperatures may range from 10° to 60° C. and especially from 15° to 40° C. Preferably, the application is made at a temperature of the scalp. In order to shorten the period of action and to improve the dyeing result, heat, especially from a heating hood, may be supplied. After a period of action of approximately 5 to 60 minutes and especially of 15 to 30 minutes, the hair dyeing agent is removed by rinsing it out of the hair, which is to be dyed. Any subsequent shampooing can be omitted if a carrier with a high concentration of surfactant, such as a dyeing shampoo, was used.

In a preferred embodiment of the invention, the application preparation contains at least one quaternary ammonium compound. This quaternary ammonium compound may, pursuant to the invention, be a component of the dyeing cream and/or of the oxidizing agent preparation. Preferably however, pursuant to the invention, the quaternary ammonium compound is a component of the oxidizing agent preparation.

Preferred quaternary ammonium compounds are ammonium halides, especially chlorides and bromides, such as alkyltrimethylammonium chlorides, dialkyldimethylammonium chlorides and trialkylmethylammonium chlorides, such as cetyltrimethylammonium chloride, stearyltrimethylammonium chloride, behenyl-trimethylammonium chloride, distearyidimethylammonium chloride, lauryldimethylammonium chloride, lauryldimethylbenzylammonium chloride and tricetylmethylammonium chloride, as well as the imidazolium compounds, known under the INCI names of Quaternium-27 and Quatemium-83. The long alkyl chain of the surfactants, named above, preferably has 10 to 18 carbon atoms. Stearyltrimethylammonium chloride is particularly preferred.

However, the so-called esterquats also are further preferred quaternary ammonium compounds. These compounds are known materials, which contain at least one ester function as well as at least one quaternary ammonium group as structure element. Quaternized ester salts of fatty acids with triethanolamine, quaternized ester salts of fatty acids with diethanolakylamines and quaternized ester salts of fatty acids with 1,2-dihydroxypropyldialkylamines are preferred esterquats. Such products are sold, for example, under the trademarks of Stepantex®, Dehyquart® und Armocare®. The products Armocare® VGH-70, an N,N-bis(2-palmitoyloxy-ethyl)dimethylammonium chloride, as well as Dehyquart® F-75, Dehyquart® C-4046, Dehyquart® L80 and Dehyquart® AU-35 are examples of such esterquats.

Alkylamidoamines are further quaternary ammonium compounds, which are preferred pursuant to the invention. The alkylamidoamines usually are prepared by amidation of natural or synthetic fatty acids and fatty acid cuts with dialkylaminoamines. Stearamidopropyldimethylamine, which is commercially available under the name of Tegoamide® S 18, is a compound of this group of substances, which is particularly suitable pursuant to the invention.

A further object of the present invention is a 2-component kit for dyeing keratinic fibers, comprising a first preparation as described above, as well as a second preparation, containing at least one oxidizing agent and at least one quaternary ammonium compound.

Reference is made to the comments above in connection with the oxidizing agents and quaternary ammonium compounds, which can be used within the scope of this object.

The inventive agents furthermore may contain all active ingredients, additives and auxiliary materials, which are known for such preparations. In many cases, these agents contain at least one surfactant. In principle, anionic, zwitterionic, ampholytic, nonionic and cationic surfactants are suitable. In many cases, however, it has proven to be advantageous to select the surfactants from anionic, zwitterionic or nonionic surfactants.

In the inventive preparations, all anionic, surface active materials, which are suitable for use with the human body, are suitable as anionic surfactants. These are characterized by a water-soluble anionic group, such as a carboxylate, sulfate, sulfonate or phosphate group, and a lipophilic alkyl group with approximately 10 to 22 carbon atoms. In addition, glycol ether groups or polyglycol ether groups, ester groups, ether groups and amide groups, as well as hydroxyl groups may be contained in the molecule. Examples of suitable anionic surfactants, in each case in the form of the sodium, potassium and ammonium as well as mono-, di and trialkanolammonium salt with 2 or 3 carbon atoms in the alkanol group, are
linear fatty acids with 10 to 22 carbon atoms (soaps),
ether carboxylic acids having the formula R—O—(CH₂—CH₂O)ₓ—CH₂—COOH, in which R is a linear alkyl group with 10 to 22 carbon atoms and x has a value of 0 or 1 to 16,
acyl sarcosides with 10 to 18 carbon atoms in the acyl group,
acyl taurides with 10 to 18 carbon atoms in the acyl group,
acyl isothionates with 10 to 18 carbon atoms in the acyl group,
monoalkyl and dialkyl sulfosuccinates with 8 to 18 carbon atoms in the alkyl group and monoalkyl polyethylene oxide sulfosuccinates with 8 to 18 carbon atoms in the alkyl group and 1 to 6 ethylene oxide groups,
linear alkanesulfonates with 12 to 18 carbon atoms
linear α-olefinsulfonates with 12 to 18 carbon atoms,
methyl esters of alpha-sulfofatty acids with 12 to 18 carbon atoms,
alkyl sulfates and alkyl polyglycol ether sulfates having the formula R—O(CH₂—CH₂O)ₓ—SO₃H, in which R preferably is a linear alkyl group with 10 to 18 carbon atoms and x has a value of 0 or 1 to 12,
mixtures of surface active hydroxy sulfonates of DE-A-37 25 030,
sulfated hydroxy alkyl polyethylene glycol ethers and/or hydroxy alkylene propylene glycol ethers of DE-A-37 23 354,
sulfonates of unsaturated fatty acids with 12 to 24 carbon atoms and 1 to 6 double bonds of DE-A-39 26 344,
esters of tartaric acid and citric acid with alcohols, which represent addition products of the reaction between about 2-15 molecules of ethylene oxide and/or propylene oxide and fatty alcohols with 8 to 22 carbon atoms.

Preferred anionic surfactants are alkyl sulfates, alkyl polyglycol ether sulfates and ether carboxylic acids with 10 to 18 carbon atoms in the alkyl group and up to 12 glycol ether groups in the molecule, as well as, in particular, salts of saturated and, in particular, unsaturated C₈ to C₂₂ carboxylic acids such as oleic acid, stearic acid, iso-stearic acid and palmitic acid.

Nonionic surfactants contain, as hydrophilic group, for example, a polyol group, a polyalkylene glycol ether group or a combination of a polyol and a polyglycol ether group. Such compounds are, in particular,
addition products of the reaction between 2 to 30 moles of ethylene oxide and/or 0 to 5 moles of propylene oxide and linear fatty alcohols with 8 to 22 carbon atoms, fatty acids with 12 to 22 carbon atoms and alkyl phenols with 8 to 15 carbon atoms in the alkyl group,
C₁₂ to C₂₂ fatty monoesters and diesters of addition products of the reaction between 1 to 30 moles of ethylene oxide and glycerin,
C₈ to C₂₂ alkyl monoglycosides and oligoglycosides and their ethoxylated analogs, as well as
addition products of the reaction between of 5 to 60 moles of ethylene oxide and castor oil and hydrogenated castor oil.

Preferred nonionic surfactants are alkyl polyglycosides of the general formula R¹O-(Z)ₓ. These compounds are characterized by the following parameters.

The alkyl group R¹ contains 6 to 22 carbon atoms and maybe linear as well as branched. Primary linear aliphatic groups and aliphatic groups with a methyl group in the 2 position are preferred. Such alkyl groups are, for example, 1-octyl, 1-decyl, 1-lauryl, 1-myristyl, 1-cetyl and 1-stearyl, of which 1-octyl, 1-decyl, 1-lauryl, 1-myristyl are particularly preferred. When so-called “oxo alcohols” are used as starting materials, compounds with an odd number of carbon atoms in the alkyl chain predominate.

The alkyl polyglycosides, which can be used pursuant to the invention, may, for example, contain only a particular R¹ alkyl group. Usually, these compounds are synthesized starting out from natural fats and oils or mineral oils. In this case, mixtures corresponding to the starting compounds or corresponding to the respective working up of these compounds are present as R alkyl groups.

Particularly preferred are those alkyl polyglycosides, in which R¹ consists
essentially of C₈ and C₁₀ alkyl groups,
essentially of C₁₂ and C₁₄ alkyl groups
essentially of C₈ to C₁₆ alkyl groups or
essentially of C₁₂ to C₁₆ alkyl groups.

Any monosaccharides or oligosaccharide can be used as sugar building block (Z). Usually, sugars with 5 or six carbon atoms, as well as the corresponding oligosaccharides are used. Examples of such sugars are glucose, fructose, galactose, arabinose, ribose, xylose, lyxose, allose, altrose, mannose, gulose, idose, talose and sucrose. Preferred sugar building blocks are glucose, fructose, galactose, arabinose and sucrose; glucose particularly preferred.

The alkyl polyglycosides, which may be used pursuant to the invention, contain, on the average, 1.1 to 5 sugary units. Alkyl polyglycosides, in which x has a value of 1.1 to 1.6, are preferred. Alkyl glycosides, in which x has a value of 1.1 to 1.4 are particularly preferred.

Aside from their surfactant effect, the alkyl glycosides may also improve the fixing of fragrance components on the hair. In the event that an effect of the perfume oil on the hair, going beyond the duration of the hair treatment, is desired, someone of ordinary skill in the art would resort preferably to this class of substance as a further constituent of the inventive preparations.

The alkoxylated homologs of the alkyl polyglycosides named can also be used pursuant to the invention. On the average, these homologs may contain up to 10 ethylene oxide units and/or propylene oxide units per alkyl glycosides unit.

Furthermore, zwitterionic surfactants may be used, particularly as co-surfactants. Zwitterionic surfactants are those surface active compounds, which carry at least one quaternary ammonium group and at least one —COO⁽⁻⁾ or —SO₃⁽⁻⁾ group in the molecule. Particularly suitable zwitterionic surfactants are the so-called betaines, such as N-alkyl-N,N-dimethylammonium glycinates, such as coconut alkyl dimethylammonium glycinate, N-acyl-aminopropyl-N,N-dimethyl-ammonium glycinate, such as coconut acylaminopropyl dimethylammonium glycinate, and 2-alkyl-3-carboxylmethyl-3-hydroxyethyl-imidazoline with, in each case, 8 to 18 carbon atoms in the alkyl or acyl group or cocnut acylaminoethylhydroxyethylcarboxymethyl glycinate. A preferred zwitterionic surfactant is the fatty acid amide derivative known under the INCI name of cocoamidopropyl betaine.

Ampholytic surfactants are likewise particularly suitable as co-surfactants. Ampholytic surfactants are understood to be those surface-active compounds, which, aside from a C₈-C₁₈ alkyl or acyl group in the molecule, contain at least one free amino group had at least one —COOH or —SO₃H group and are capable of forming an internal salt. Examples of suitable ampholytic surfactants are N-alkylglycine, N-alkylpropionic acids, N-alkylaminobutyric acids, N-alkyliminodipropionic acids, N-hydroxyethyl-N-alkylamidopropylg-lycine, N-alkyltaurine, N-alkyl-sarcosine, 2-alkylaminopropionic acids and alkylaminoacetic acids with, in each case, 8 to 18 carbon atoms in the alkyl group. The N-coconutalkylaminopropionate, the coconutacylacylaminopropionate and the C₁₂₋₁₈ acylsarcosine are particularly preferred ampholytic surfactants.

Aside from the quaternary ammonium compounds already named above, the quaternized protein hydrolysates represent further cationic surfactants, which can be used pursuant to the invention.

The commercial product, Glucquat® 100, which, according to INCI nomenclature is a lauryl methyl couceth-10 hydroxypropyl dimonium chloride, is an example of a quaternary sugar derivative, which can be used as a cationic surfactant.

The compounds with alkyl groups, which are used as surfactant, may, in each case, be uniform substances. As a rule, however, for the production of these materials, it is preferred if the synthesis starts out from native vegetable or animal raw materials, so that substance mixtures with alkyl chains of different length are obtained, depending on the respective raw material.

For surfactants, which represent products of the addition reaction between ethylene oxide and/or propylene oxide and fatty alcohols or derivatives of these addition products, products with a “normal” distribution of homologs as well as those with a restricted distribution of homologs can be used. Mixtures of homologs, which are obtained by reacting fatty alcohol and alkylene oxide using alkali metals, alkali metal hydroxides or alkali metal alcoholates as catalysts, are understood to have a “normal” distribution of homologs. On the other hand, restricted distributions of homologs are obtained if, for example, hydrotalcite, alkaline earth metal salts of ethercarboxylic acids or alkaline earth metal oxides, hydroxides or alcoholates are used as catalysts. The use of products with a restricted distribution of homologs may be preferred.

Moreover, the inventive agents preferably may contain yet another conditioning active ingredient, selected from the group comprising cationic surfactants, cationic polymers, alkylamidoamines, paraffin oils, vegetable oils and synthetic oils.

Cationic polymers may be preferred as conditioning active ingredients. As a rule, these are polymers, which contain a quaternary nitrogen atom, for example, in the form of an ammonium group. Preferred cationic polymers are, for example,
quaternized cellulose derivatives, such as those commercially available under the names of Celquat® and Polymer JR®. The compounds Celquat® H 100, Celquat® L 200 and Polymer JR® 400 are preferred quaternized cellulose derivatives.
copolymers of vinylpyrrolidone and quaternized derivatives of dialkylamino acrylate and methacrylate, such as vinylpyrrolidone dimethylamino methacrylate copolymers quaternized with dimethyl sulfate. Such compounds are commercially obtainable under the names of Gafquat® 734 and Gafquat®755.
vinylpyrrolidone methoimidazolinium copolymers, such as those offered under the name of Luviquat®.
quaternized polyvinyl alcohol
   as well as the polymers with quaternary nitrogen atoms in the main chain, known under the names of
Polyquaternium-2,
Polyquaternium-17,
Polyquaternium-18 and
Polyquaternium-27.

Cationic polymers of the four groups named first are especially preferred and Polyquaternium-2, Polyquaternium-10 and Polyquaternium-22 are particularly preferred.

Paraffin oils, synthetic, oligomeric alkenes and vegetable oils such as jojoba oil, sunflower oil, orange oil, almond oil, wheat germ oil and peach kernel oil, may also be used as conditioning active ingredients.

Phospholipids, such as soybean lecithin, egg lecithin and cephalins, as well as these substances known under the names of linoleamidopropyl PG-Dimonium chloride phosphate, cocamidopropyl PG-Dimonium chloride Phosphate und stearamidopropyl PG-Dimonium chloride phosphate are likewise suitable hair-conditioning compounds. These are sold, for example by the Mona company under the commercial names of Phospholipid EFA®, Phospholipid PTC® as well as Phospholipid SV®.

Further active ingredients, auxiliary materials and additives are, for example,
nonionic polymers, such as vinylpyrrolidone/vinyl acrylate copolymers, polyvinylpyrrolidone and vinylpyrrolidone/vinyl acetate copolymers and polysiloxanes,
zwitterionic and amphoteric polymers such as acrylamidopropyl-tri-methylammonium chloride/acrylate copolymers and octylacrylamide/methyl methacrylate/t-butylaminoethyl methacrylate/2-hydroxypropyl methacrylate copolymers,
anionic polymers, such as polyacrylic acids, cross-linked polyacrylic acids, vinyl acetate/crotonic acid copolymers, vinylpyrrolidone/vinyl acrylate copolymers, vinyl acetate/butyl maleate/isobornyl acrylate copolymers, methyl vinyl ether/maleic anhydride copolymers and acrylic acid/ethyl acrylate/N-t-butyl acrylamide terpolymers,
thickening agents such as agar, guar gum, alginates, xanthan gum, gum Arabic, gum karaya, carob seed flour, linseed gum, dextrans, cellulose derivates, such as, methylcellulose, hydroxyalkylcellulose and carboxymethylcellulose, starch fractions and derivatives, such as, amylose, amylopectin and dextrin, clays, such as bentonite or fully synthetic hydrocolloids, such as polyvinyl alcohol,
structurants, such as maleic acid and lactic acid,
protein hydrolysates, especially elastin, collagen, keratin, casein, soy protein and wheat protein hydrolysates, and their condensation products with fatty acids, as well as quaternized protein hydrolysates,
perfume oils, dimethylisosorbide and cyclodextrines,
solvents and solubilizers, such as ethanol, isopropanol, ethylene glycol, propylene glycol, glycerin and diethylene glycol,
active ingredients to improve fiber structure, such as mono-, di- and oligosaccharides, for example, glucose, galactose, fructose, levulose and lactose,
quaternized amines, such as methyl-1-alkylamidoethyl-2-alkylimidazolinium methosulfate
defoamers, such as silicones,
dyes for coloring the agent,
anti-dandruff materials, such as piroctone olamines, zinc omadines and climbazole,
light protectants, especially derivatized benzophenones, cinnamic acid derivatives and triazines,
substances for adjusting the pH, such as conventional acids and, in particular, edible acids and bases,
active ingredients, such as allantoin, pyrollidone carboxylic acids and their salts, as well as bisabolol,
vitamins, provitamins and vitamin precursors, especially those of groups A, B₃, B₅, B₆, C, E, F and H,
plant extracts, such as extracts of green tea, oak bark, stinging nettle, hamamelis, hops, chamomile, burr root, horsetail, hawthorn, linden tree flowers, almond, aloe vera, pine needles, horse chestnuts, sandalwood, juniper, coconut, mango, apricot, lemon, wheat, kiwi, melon, orange, grapefruit, sage, rosemary, birch, mallow, meadow cress, creeping thyme, milfoil, thyme, melissa, restharrow, coltsfoot, hibiscus, meristem, ginseng and ginger root,
cholesterol
thickeners, such as sugar esters, polyol esters or polyol alkyl ethers,
fats and waxes, such as spermaceti, beeswax, lignite wax and paraffins,
fatty acid alkanolamides,
complexing agents, such as EDTA, NTA, β-alanine diacetic acid and phosphonic acids,
swelling agents and penetrants, such as glycerin, propylene glycol monomethyl ethers, carbonates, hydrogen carbonates, guanidines, ureas, as well as primary, secondary and tertiary phosphates,
opacifiers, such as latex, styrene/PVP copolymers and styrene/acrylamide copolymers,
pearl glossing agents, such as ethylene glycol monostearate and distearate as well as PEG-3 distearate,
pigments,
stabilizers for hydrogen peroxides and other oxidizing agents,
blowing agents, such as propane-butane mixtures, N₂O, dimethyl ether, carbon dioxide and air
antioxidants.

With respect to further optional components, as well as the amounts of these components used, reference is made explicitly to the relevant handbooks, which are known to those of ordinary skill in the art, such as Kh. Schrader, Grundlagen und Rezepturen der Kosmetika (Fundamentals and Formulations of Cosmetics), 2^{nd} Edition, Huthig Buch Verlag, Heidelberg, 1989.

The following examples are intended to explain the object of the present application in greater detail.

### EXAMPLES

The following dyeing agents were prepared (unless stated otherwise, all quantitative data is in parts per weight).

1. Dyeing Creams A-D

| | |
|---|---|
| Fatty alcohol mixture C₁₂-C₁₈ | 7.5 |
| Eutanol G⁵ | 1.0 |
| Eumulgin ® B1⁴ | 0.5 |
| Eumulgin ® B2¹ | 0.4 |
| Plantacare ® 1200² | 3.0 |
| Dehyton ® K³ | 2.5 |
| Ammonium sulfate | 0.5 |
| Sodium sulfite | 0.8 |
| Dye mixture a-d | as given in Table 1 |
| Ammonia (25-% in water) | to a pH of 10 |
| Water | to 100 |

¹Cetearyl alcohol with approx. 20 EO units (INCI name: Ceteareth-20) (COGNIS)
²C12-16 fatty alcohol-1,4-glucoside (approx. 50% active substance; INCI-name: lauryl glucoside) (COGNIS)
³Fatty acid amide with a betaine structure (approx. 30% active substance; INCI name: Cocamidopropyl betaine) (Henkel)
⁴Cetyl stearyl alkohol + 12 EO (INCI name: Ceteareth-12) (COGNIS)
⁵2-Octyldodecyl fatty alcohol, INCI name: octyldodecanol (COGNIS)

TABLE 1

| | Dye mixture | | | |
|---|---|---|---|---|
| | a | b | c | d |
| PTD sulfate | 0.3 | 0.2 | 0.17 | 0.4 |
| TAP sulfate | | | | 1.6 |
| Oxyred | 0.9 | 0.36 | | 0.05 |
| Resorcinol | | | | 0.1 |
| 2-Methylresorcinol | | | 0.03 | 1.0 |
| 4-Chlororesorcinol | 0.08 | | 0.12 | |
| m-Aminophenol | | | 0.03 | |
| Methyl yellow | 0.1 | | | |
| p-Amino-o-cresol | 0.9 | 0.1 | | |
| 2,7-Dihydroxynaphthalene | | 0.17 | | |
| 6-Chloro-4-nitro-2-aminophenol | | 0.1 | | |

In each case, 1 part of the dyeing agent described above was mixed with 1 part of a 6% hydrogen peroxide solution for the dyeing. Optionally, the care polymer (I=Silsoft® A843, II=polymer JR 400 from Amerchol, III=Silsoft® A454, IV=polymer W 37194 from Stockhausen) was used previously. Care polymers II and IV are comparison products from the prior art. Polymer W 37194 from Stockhausen is a copolymer of the sodium salt of acrylic acid and acrylamidopropyltrimethylammonium chloride in water. Polymer JR 400 from Amerchol is a quaternized hydroxyethylcellulose, the INCI name of which is Polyquaternium-10.

Especially the polymer W 37194 leads to viscosity problems when used at higher concentrations.

This application preparation was applied on naturally white human hair (from Alkinco) in a liquor ratio of 1:4, left there for 30 minutes and then rinsed out. The results of the dyeings were investigated calorimetrically and summarized in the following:

| | Dyeing Agent | | | |
|---|---|---|---|---|
| | A | B | C | D |
| Dyeing Result | Copper red | Copper gold | Brown | Red |

The chrominance C* was measured colorimetrically by the CieLAB method (compare WO 01/21145). According to the principle ΔC* (chrominance difference)=C*sample−C*standard, a positive value for ΔC*means that the sample is purer in color. The values obtained confirm that, by the addition of polymer, a purer color is obtained. The most advantageous addition is that of polymer I at a concentration of 0.5%, followed by polymer III:

Dyeing agent

| | A | B | C | D |
|---|---|---|---|---|
| C* (without | 24.69 | 27.36 | 14.37 | 26.44 |
| polymer) | | | | |
| C* (with 0.75% | — | — | 17.12 | — |
| AS I) | | | | |
| C* (with 0.5% | 27.98 | 29.64 | 16.78 | 29.25 |
| AS I) | | | | |
| C* (with 0.75% | 26.25 | 29.52 | 16.16 | 27.94 |
| AS II) | | | | |
| C* (with 0.5% | 26.83 | 28.55 | 16.15 | 27.82 |
| AS II) | | | | |
| C* (with 0.75% | — | — | 16.88 | 28.03 |
| AS III) | | | | |
| C* (mit 0.5% | — | — | 16.97 | 28.87 |
| AS III) | | | | |
| C* (with 0.75% | — | — | 16.55 | 28.03 |
| ASII) | | | | |

Furthermore, the Δa* values were determined. According to the formula Δa* (color difference at the red/green axis)=a* of sample−a* of prototype, a positive value for Δa* means that the prototype is more red. The values obtained showed that, by the addition of polymer, a more red color result is achieved for the red nuances, which are predominantly selected here. Here also, polymer I was the best additive, especially in a concentration of 0.5%, and polymer III was the second best additive.

Dyeing Agent

| | A | B | C | D |
|---|---|---|---|---|
| A* (without | 21.94 | 16.24 | 4.76 | 23.79 |
| polymer) | | | | |
| a* (with 0.75% | 23.38 | — | 5.26 | 24.87 |
| AS I) | | | | |
| a* (with 0.5% | 23.06 | 17.39 | 5.44 | 24.99 |
| AS I) | | | | |
| a* (with 0.75% | 21.81 | 17.11 | 5.03 | 23.73 |
| AS II) | | | | |
| a* (with 0.5% | 21.75 | 17.03 | 5.11 | 23.71 |
| ASII) | | | | |
| a* (with 0.75% | 22.76 | — | — | 24.85 |
| AS III) | | | | |
| a* (with 0.5% | 22.98 | — | 5.33 | 24.88 |
| AS III) | | | | |
| a* (with 0.75% | 22.55 | — | 5.18 | 23.99 |
| AS IV) | | | | |

Moreover, the washfastness of the nuances on normal hair, exposed to the weather, was tested. The residual color intensity (tinctorial strength) F (%) was determined in comparison to that of unwashed strands (=100% color intensity). The dyeing of the strands was determined calorimetrically at 4 points with the Datacolor Text Flash of Data Color International, the results were evaluated with the Data Color Tools QC software according to a formula (I) and summarized in the following Tables. The dyeing of an unwashed strain served as a reference.

$$Tinctorial strength = 100 ⨯ \frac{K / S ( sample )}{K / S ( reference )} ( \% )$$

in which
K is the absorption coefficient
S is the scattering coefficient
K/S is the reflection coefficient

The results of the measurements clearly show that better washfastness is achieved by the addition of polymer. Polymer III is the most advantageous here and is followed by polymer I:

Deying Agent

| | A | B | C | D |
|---|---|---|---|---|
| F (without | 82.3 | 75.8 | 79.3 | 85.4 |
| polymer) | | | | |
| F (with 0.75% | — | 78.9 | 91.8 | 97.5 |
| AS I) | | | | |
| F (with 0.5% | 88.0 | 82.9 | 91.2 | 91.6 |
| AS I) | | | | |
| F (with 0.75% | 84.2 | 75.1 | 88.7 | 92.9 |
| AS II) | | | | |
| F (with 0.5% | 83.9 | 77.2 | 82.5 | 89.3 |
| AS II) | | | | |
| F (with 0.75% | 89.9 | 85.7 | 95.3 | 97.4 |
| AS III) | | | | |
| F (with 0.5% | 89.5 | 84.9 | 94.9 | 97.0 |
| AS III) | | | | |
| F (with 0.75% | 85.3 | 79.9 | — | 90.5 |
| AS IV) | | | | |

Furthermore, the washfastness of the nuances was tested on highly stressed hair. The residual color intensity (tinctorial strength) F (%) was determined in comparison to the unwashed strands (=100% color intensity). The results of the measurements clearly showed that better washfastness is achieved by adding polymer. Once again, polymer III was the most advantageous.

Dyeing Agent

| | A | B | C | D |
|---|---|---|---|---|
| F (without | 66.6 | — | 62.4 | — |
| polymer) | | | | |
| F (with 0.75% | — | — | — | — |
| AS I) | | | | |
| F (with 0.5% | 84.9 | — | 70.7 | — |
| AS I) | | | | |
| F (with 0.75% | 79.2 | — | 68.0 | — |
| AS II) | | | | |
| F (with 0.5% | 72.3 | — | 63.5 | — |
| AS II) | | | | |
| F (with 0.75% | 82.3 | — | 72.5 | 93.7 |
| AS III) | | | | |
| F (with 0.5% | 85.7 | — | 78.1 | 93.8 |
| AS III) | | | | |
| F (with 0.75% | 82.9 | — | 70.2 | 90.8 |
| AS IV) | | | | |

The finishing performance of the polymers was tested in comparison (in dyeing agent C) as a further parameter. It was tested in the testing salon using 5 models. The finishing was tested according to the school grade system:

| Polymer | Model 1 | Model 2 | Model 3 | Model 4 | Model 5 |
|---|---|---|---|---|---|
| I, 0.5% | 1 | 1 | 1.5 | 1 | 1 |
| I, 0.75% | 1 | 1 | 1 | 1 | 1 |
| II, 0.5% | 2.5 | 2 | 3 | 2.5 | 2.5 |
| II, 0.75% | 2.5 | 2 | 2.5 | 2.5 | 2.5 |
| III, 0.5% | 2 | 1.5 | 2 | 2 | 2 |
| III, 0.75% | 1.5 | 1 | 2 | 1.5 | 1.5 |
| without | 4 | 3.5 | 4 | 3 | 4.5 |

Result: Even in small concentrations, polymer I and III are better than polymer II in the finishing.

In comparison to the comparison polymers, organosiloxanes copolymers, used pursuant to the invention, show a constant viscosity, independent of the electrolyte content. In addition, the cream emulsions, which contain the inventive organosiloxane copolymers, have a better consistency.

In comparison to polymer JR 400, Silsoft® A-843 provides a significant care performance even when used at significantly lower concentrations. This care performance increases as the amount used increases. In comparison to polymer W 37194, an improved color and care performance of the formulation can be achieved at a lower concentration.

2. Dyeing Cream E

| | |
|---|---|
| 50% KOH | 2.45 |
| Carbomer⁶ 934 | 0.15 |
| TiO₂ | 0.5 |
| polyethylene glycol 600 | 0.6 |
| Laureth sulfate Na, 27% | 4.4 |
| Lanette⁷ E | 0.5 |
| Potassium oleate soap, 12.5% | 3.0 |
| Emulgin B2 | 3.0 |
| Eutanol G | 2.0 |
| cetyl/stearyl alcohol 50:50 | 10.2 |
| Cutina⁸ AGS | 2.0 |
| Cutina⁹ GMS-SE | 1.0 |
| Mixture of dyes | 5.6 |
| Tetrasodium EDTA | 0.1 |
| Tetrasodium EDTA | 0.2 |
| Silsoft ® A-843 | 0.5 |
| Merquat¹¹ Plus 3330 | 1.5 |
| ascorbic acid | 0.05 |
| sodium sulfite | 0.2 |
| monoethanolamine | 3.0 |
| essential oil 14213 | 0.14 |
| water | up to 100 |

Dye Mixture:

| | |
|---|---|
| Highly disperse silica | 0.25 |
| p-toluenediamine sulfate | 3.24 |
| resorcinol | 0.81 |
| m-aminophenol | 0.16 |
| 4-chlororesorcinol | 0.57 |
| 2,4-diaminophenoxyethanol 2 HCl | 0.58 |
| | 5.6 |

Developer F

| | |
|---|---|
| dipicolinic acid | 0.1 |
| 50% KOH | 0.3 |
| natrium benzoate | 0.04 |
| sodium pyrophosphate | 0.1 |
| Turpinal¹² SL | 0.4 |
| 1,2-propylene glycol | 0.4 |
| cetyl/stearyl alcohol 50:50 | 4.0 |
| Dehyquart¹³ B | 0.75 |
| Emulgin B2 | 1.2 |
| paraffin oil | 0.3 |
| 50% H₂O₂ | 6.2 or 12.2 or 8.4 |

The dyeing cream and the developer (with 4% hydrogen peroxide) were mixed in a ratio by weight of 1:2 for the application. The development time was about 20 minutes.

| | |
|---|---|
| 6 | Acrylic acid, cross-linked with polyalkylene polyether (INCI name: |
| | Carbomer) (Noveon) |
| 7 | Sodium salt of fatty alcohol sulfate (INCI name: sodium cetearyl |
| | sulfate) (Henkel) |
| 8 | Ethylene glycol distearate (Cognis) |
| 9 | Glyceryl stearate (INCI name: olyceryl stearate SE) (Cognis) |
| 10 | INCI name: linoleamidopropyl-PG-dimonium chloride phosphate |
| | (Uniqema) |
| 11 | Dimethyldialkylammonium chloride-acrylic acid-acrylamide |
| | terpolymer (INCI name: Polyquaternium-39) (Ondeo-Nalco) |
| 12 | 1-hydroxyethane-1,1-diphosphonic acid (HEDP) (INCI name: |
| | etidromic acid, aqua) (Solutia) |
| 13 | Stearyltrimethylammonium chloride (INCI name: steartrimonium |
| | chloride) (Cognis) |

1-21. (canceled)

22. An oxidative dyeing agent for keratinic fibers comprising: (a) a component selected from the group consisting of direct dyes, dye precursors, and combinations thereof; and (b) an organosilicone block copolymer having one or more polyoxyalkylene blocks, one or more polysiloxane blocks and at least two amino groups covalently linked to the main polymer chain or to the chain ends.

23. The oxidative dyeing agent according to claim 22, wherein the organosilicone block copolymer comprises a random block copolymer of polyethylene oxide blocks, polypropylene oxide blocks and polysiloxane blocks.

24. The oxidative dyeing agent according to claim 22, wherein the organosilicone block copolymer comprises a random block copolymer of polyethylene oxide blocks, polypropylene oxide blocks and polydimethylsiloxane blocks.

25. The oxidative dyeing agent according to claim 22, wherein at least one of the at least two amino groups comprises a primary or a secondary amino group.

26. The oxidative dyeing agent according to claim 25, wherein the organosilicone block copolymer comprises repeating units of the general formula (I):
[SiMe₂-O—(SiMe₂-O—)ₓSiMe₂-R—NH—R′—O—(C₂H₄O)ₐ—(C₃H₆O)_{b}—R′NH—R] (I)
wherein x represents a number of 3 to 500, a represents a number of 1 to 300, b represents a number of 0 to 300, each R and each R′ independently represents a bivalent organic group.

27. The oxidative dyeing agent according to claim 26, wherein x represents a number of 5 to 300, a represents a number of 5 to 200, b represents a number of 4 to 200, each R and each R′ independently represents an organic group selected from the group consisting of linear C₂₋₂₀ alkylene groups, hydroxyl-substituted linear C₂₋₂₀ alkylene groups, linear C₂₋₂₀ alkylene groups containing one or more nonadjacent —O—, —C(O)—, —O—C(O)—, —C(O)—O— groups and hydroxyl-substituted linear C₂₋₂₀ alkylene groups containing one or more nonadjacent —O—, —C(O)—, —O—C(O)—, —C(O)—O— groups.

28. The oxidative dyeing agent according to claim 26, wherein x represents a number of 10 to 300, a represents a number of 5 to 100, b represents a number of 5 to 100, each R independently represents a linear C₃₋₁₀ alkylene group, which is substituted by at least one OH group and interrupted by at least one —O— group, and each R′ independently represents a linear C₁₋₅ alkylene group.

29. The oxidative dyeing agent according to claim 25, wherein the organosilicone block copolymer has a terminal primary amino group.

30. The oxidative dyeing agent according to claim 22, wherein at least one of the at least two amino groups comprises a tertiary amino group.

31. The oxidative dyeing agent according to claim 30, wherein the organosilicone block copolymer comprises repeating units of the general formula (II):
[(SiMe₂-O—)_{y}SiMe₂-R¹-]ᵥNR²[R³—(OC₂H₄)_{c}—(OC₃H₆)_{d}—R⁴—NR⁵]_{w} (II)
wherein y represents a number of 3 to 500, v represents a number of 1 to 50, w represents a number of 1 to 50, c represents a number of 1 to 300, d represents a number of 0 to 300, R¹, R³ and R each independently represents a bivalent organic group, R² and R⁵ each independently represents an organic group selected from the group consisting of C₁₋₆ alkyl groups, phenyl groups, and hydroxyl-substituted C₁₋₆ alkyl or phenyl groups.

32. The oxidative dyeing agent according to claim 31, wherein y represents a number of 5 to 300, c represents a number of 5 to 200, d represents a number of 4 to 200, R¹, R³ and R⁴ each independently represents an organic group selected from the group consisting of linear C₂₋₂₀ alkylene groups, hydroxyl-substituted linear C₂₋₂₀ alkylene groups, linear C₂₋₂₀ alkylene groups containing one or more nonadjacent —O—, —C(O)—, —O—C(O)—, —C(O)—O— groups and hydroxyl-substituted linear C₂₋₂₀ alkylene groups containing one or more nonadjacent —O—, —C(O)—, —O—C(O)—, —C(O)—O— groups, and R² and R⁵ each independently represents a C₁₋₄ alkyl group.

33. The oxidative dyeing agent according to claim 22, wherein the organosilicone block copolymer comprises a salt of a C₁₆₋₂₄ fatty acid.

34. The oxidative dyeing agent according to claim 26, wherein the organosilicone block copolymer comprises a salt of a C₁₆₋₂₄ fatty acid.

35. The oxidative dyeing agent according to claim 31, wherein the organosilicone block copolymer comprises a salt of a C₁₆₋₂₄ fatty acid.

36. The oxidative dyeing agent according to claim 22, wherein the dye precursor comprises a precursor selected from the group consisting of developer components, coupler components and combinations thereof.

37. A method comprising
(a) providing a keratinic fiber to be dyed; and
(b) contacting the keratinic fiber with an composition comprising: (a) a component selected from the group consisting of direct dyes, dye precursors, and combinations thereof; and (b) an organosilicone block copolymer having one or more polyoxyalkylene blocks, one or more polysiloxane blocks and at least two amino groups covalently linked to the main polymer chain or to the chain ends.

38. The method according to claim 37, wherein the composition further comprises an oxidizing agent.

39. The method according to claim 37, further comprising contacting the keratinic fiber with an oxidizing agent subsequent to contacting the keratinic fiber with the composition.

40. The method according to claim 37, further comprising contacting the keratinic fiber with a combination of an oxidizing agent and a second composition comprising an organosilicone block copolymer having one or more polyoxyalkylene blocks, one or more polysiloxane blocks and at least two amino groups covalently linked to the main polymer chain or to the chain ends, subsequent to contacting the keratinic fiber with the composition.

41. A kit for dyeing keratinic fibers comprising: (a) a first preparation; and (b) a second preparation; wherein the first preparation comprises an oxidative dyeing agent comprises (i) a component selected from the group consisting of direct dyes, dye precursors, and combinations thereof, and (ii) an organosilicone block copolymer having one or more polyoxyalkylene blocks, one or more polysiloxane blocks and at least two amino groups covalently linked to the main polymer chain or to the chain ends; and wherein the second preparation comprises an oxidizing agent.
